(19) United States
(12) Patent Application Publication
(10) Pub. No.: US 2009/0073293 A1
(43) Pub. Date: Mar. 19, 2009

(54) CMOS image sensors with increased dynamic range and methods of operating the same

(76) Inventors: Yoel Yaffe, Modiin (IL); Mickey Bahar, Natanya (IL); Eugene Fainstain, Natanya (IL); Leonid Brailovsky, Herzliya (IL); Artem Zinevich, Tel Aviv (IL); Evgeny Artyomov, Rehovot (IL)

Correspondence Address: HARNESS, DICKEY & PIERCE, P.L.C., P.O. BOX 8910, RESTON, VA, 20195, US

(21) Appl. No.: 12/213,995

(22) Filed: Jun. 27, 2008

Related U.S. Application Data
(60) Provisional application No. 60/946,577, filed on Jun. 27, 2007.

(51) Int. Cl. H04N 5/335

(52) U.S. Cl. 348/297; 348/E05.091

(57) ABSTRACT

A method of operating an image sensor apparatus is provided. In this method, first digital image data is generated based on a first exposure data signal, wherein the first exposure data signal is indicative of an exposure level of the image sensor during a first exposure period. The first digital image data is stored in a storage circuit. Second digital image data is generated based on a second exposure data signal, wherein the second exposure data signal is indicative of an exposure level of the image sensor during a second exposure period. The second exposure period is different from the first exposure period. The second digital image data associated with the image sensor is selectively stored based on a value of the first digital image data associated with the image sensor.

### CROSS REFERENCES TO RELATED APPLICATIONS

This non-provisional patent application claims priority under 35 U.S.C. § 119(e) to U.S. Provisional Application Ser. No. 60/946,577, filed Jun. 27, 2007, the entire contents of which is incorporated herein by reference.

This application is also related to co-pending, commonly assigned U.S. application Ser. Nos. 11/345,642, filed Jan. 31, 2006, and 11/769,039, filed Jun. 27, 2007, the entire contents of each of which are incorporated herein by reference.

### BACKGROUND

Dynamic range of a conventional image sensor refers to the potential range of values between light and dark areas of an image generated by an image sensor. Conventionally, dynamic range of a captured image may be increased by acquiring multiple images of the same scene and merging the multiple images into a single, relatively wide dynamic range image. This may be accomplished using multiple image sensors and/or by using sequential image acquisitions with different exposure settings. However, using multiple image sensors increases costs because multiple image sensors are required and because of the relatively high precision required to optically align the image sensors. Using multiple sequential image acquisitions is cheaper, but may be more susceptible to motion artifacts because the acquisitions do not take place simultaneously or concurrently.

### SUMMARY

Example embodiments may improve dynamic range of images captured with image sensors (e.g., CMOS image sensors) using, for example, multi-exposure techniques. In at least one example embodiment, the multi-exposure techniques refer to a dual exposure techniques.

At least one example embodiment provides a method of operating an image sensor apparatus. According to at least this example embodiment, first digital image data may be generated based on a first exposure data signal. The first exposure data signal may be indicative of an exposure level of an image sensor during a first exposure period. The first digital image data may be stored. Second digital image data may be generated based on a second exposure data signal. The second exposure data signal may be indicative of an exposure level of the image sensor during a second exposure period. The second exposure period may be shorter than the first exposure period, and may follow the first exposure period. The second digital image data associated with the image sensor may be selectively stored based on a value of the first digital image data associated with the image sensor.

At least one other example embodiment provides a method of operating an image sensor apparatus. According to at least this example embodiment, first digital image data may be generated based on a first exposure data signal. The first exposure data signal may be indicative of an exposure level of an image sensor during a first exposure period. The first digital image data may be stored. Second digital image data may be generated based on a second exposure data signal. The second exposure data signal may be indicative of an exposure level of the image sensor during a second exposure period. The second exposure period may be different from the first exposure period and may follow the first exposure period. The second digital image data associated with the image sensor may be selectively stored based on a value of the first digital image data associated with the image sensor.

According to at least some example embodiments, the image sensor may be exposed to light for the first exposure period, and the generating of the first digital image data may include: receiving the first exposure data signal from the image sensor, and digitizing the first exposure data signal to generate the first digital image data.

According to at least some example embodiments, the image sensor may be exposed to light for the second exposure period, and the generating of the second digital image data signal may include: receiving the second exposure data signal from the image sensor, and digitizing the second exposure data signal to generate the second digital image data. The second exposing of the image sensor may occur concurrently with the digitizing of the first exposure data signal or storing of the first digital image data.

According to at least some example embodiments, exposing of the image sensor may include: applying a reset signal to a row of an image sensor array including the image sensor to begin the first exposure period, and applying a read signal to the row of the image sensor to end the first exposure period. The applying of the read signal may initiate reading out of the first exposure data signal from the image sensor.

According to at least some example embodiments, exposing of the image sensor may include: applying a reset signal to a row of an image sensor array including the image sensor to begin the second exposure period, and applying a read signal to the row of the image sensor array to end the second exposure period. The applying of the read signal may initiate reading out of the second exposure data signal from the image sensor.

According to at least some example embodiments, a saturation flag bit associated with the stored first digital image data may be analyzed, and the second digital image data may be selectively stored based on the value of the saturation flag bit. The saturation bit may be indicative of whether a value of the first digital image data is greater than a threshold value. The value of the first digital image data may be compared with a threshold value, the saturation flag bit may be set to a first value if the value of the first digital image data is greater than the threshold value, and the saturation flag bit may be stored in association with the first digital image data.

According to at least some example embodiments, the second digital image data may be stored if the saturation bit is set to the first value. The second digital image data may not be stored if the saturation bit is not set to a first value.

At least one other example embodiment provides an image sensor apparatus. The image sensor apparatus may include an image sensor array, a sample and hold unit and a storage circuit. The image sensor array may include a plurality of image sensors arranged in a plurality of rows and columns. Each image sensor may be configured to output a first and a second exposure data signal, wherein the first exposure data signal is indicative of an exposure of the image sensor to light during a first exposure period, and the second exposure data signal is indicative of an exposure of the image sensor to light during a second exposure period. The first exposure period may be longer than the second exposure period, and the second exposure period may be subsequent to the first exposure period.

In at least this example embodiment, the sample and hold unit may be configured to, for each image sensor, digitize the first exposure data signal to generate first digital image data, and digitize the second exposure data signal to generate second digital image data. The storage circuit may be configured to, for each image sensor, store the first digital image data, and selectively store the second digital image data based on a value of the stored first digital image data.

According to at least some example embodiments, the second digital image data may be stored in the storage circuit if the value of the first digital image data is greater than a saturation threshold value. The storage circuit may selectively store, for each image sensor, the second digital image data based on a value of a saturation flag bit. The saturation flag bit may be indicative of whether the value of the first stored digital image data is above a saturation threshold value. The storage circuit may store, for each image sensor, the second digital image data if the value of a saturation flag bit indicates that the value of the first stored digital image data is greater than a saturation threshold value.

According to at least some example embodiments, the sample and hold unit may be further configured to compare the value of the first digital image data with a saturation threshold value, set a saturation flag bit to a first or a second value if the value of the first digital image data is greater than the saturation threshold value (the first and second values may be different), and store the saturation flag bit in association with the first digital image data. The storage circuit may store or discard the second digital image data based on whether the saturation flag bit is set to the first or second value.

According to at least some example embodiments, the first digital image data and the second digital image data may be combined to generate resultant digital image data if the saturation bit is set to a first value. In combining the first and second digital image data, the first digital image data may be scaled according to a ratio between the first exposure period and the second exposure period such that the first and second digital image data have the same digital scale. An estimation result may be generated by evaluating an estimation function based on the second digital image data. The estimation result may be compared with a first and a second threshold value. The first threshold value may be greater than the second threshold. The first and second digital image data may be weighted based on a result of the comparing step. The weighted first and second digital image data may be combined to generate the resultant digital image data.

According to at least some example embodiments, an auto-calibrated offset may be calculated based on the first and second digital image data. The auto-calibrated offset may be applied to the scaled first digital image data when combining. The auto-calibrated offset may be calculated by: subtracting a value of each of a portion of the pixels of the second digital image data from a corresponding pixel value of the scaled first digital image data to generate a plurality of difference results and calculating an average of the generated difference results.

According to at least some example embodiments, at least a third digital image data may be generated based on a third exposure data signal. The third exposure data signal may be indicative of an exposure level of the image sensor during a third exposure period. The third exposure period may be different from at least one of the first and second exposure periods and may follow the second exposure period. The third digital image data may be selectively stored based on a value of at least one of the first and second digital image data associated with the image sensor.

### BRIEF DESCRIPTION OF THE DRAWINGS

Example embodiments will be described in connection with the example embodiments shown in the drawings in which:

FIG. 1 illustrates an apparatus according to an example embodiment;

FIG. 2 is a timing diagram showing example timing of reset and read pulses output by the x-decoder 220 for four consecutive rows i, i+1, i+2, and i+3, where i represents one of rows ROW-1 through ROW-N;

FIG. 3 is a flow chart illustrating a method of processing the first output signals S-1-1, . . . , S-1-M according to an example embodiment; and

FIG. 4 is a flow chart illustrating a method for processing the second output signal S-2-m for the m-th image sensor according to an example embodiment.

### DETAILED DESCRIPTION OF EXAMPLE EMBODIMENTS

Various example embodiments of the present invention will now be described more fully with reference to the accompanying drawings in which some example embodiments of the invention are shown. In the drawings, the thicknesses of layers and regions are exaggerated for clarity.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiments relate to image sensors and methods of operating the same. Example embodiments will be described herein with reference to complimentary metal oxide semiconductor (CMOS) image sensors (CIS); however, those skilled in the art will appreciate that example embodiments are applicable to other types of image sensors.

Specific details are provided in the following description to provide a thorough understanding of example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Example embodiments may improve dynamic range of images captured with image sensors (e.g., CMOS image sensors) using, for example, multi-exposure techniques. In at least one example embodiment, the multi-exposure techniques refer to a dual exposure techniques.

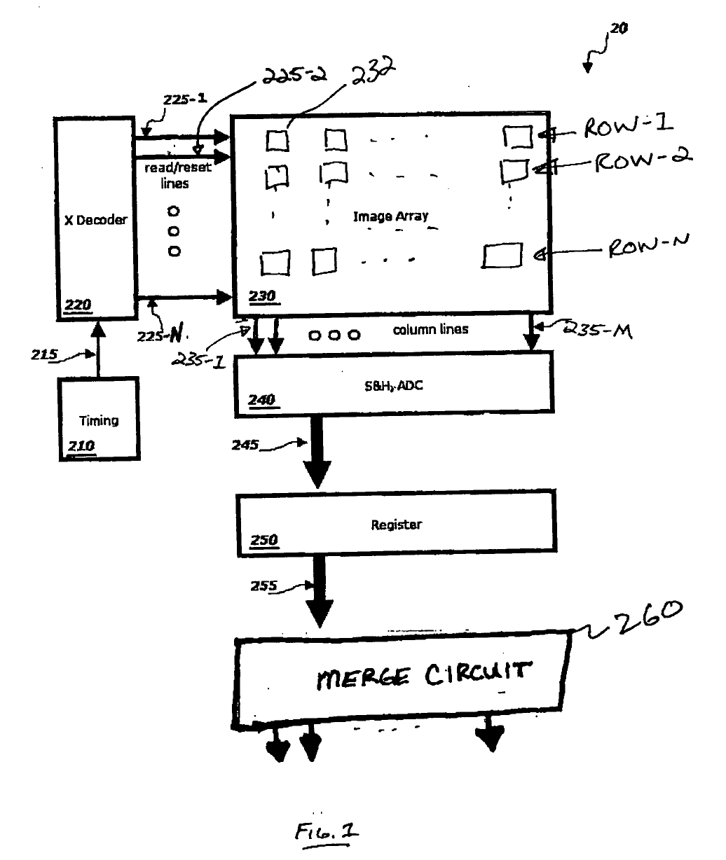

FIG. 1 illustrates an image sensing apparatus 20 according to an example embodiment. Referring to FIG. 1, a timing unit or circuit 210 may control an x-decoder 220 through one or more control lines 215. In one example, the timing unit 210 may cause the x-decoder 220 to generate a plurality of read and reset pulses. The x-decoder 220 may output the plurality of read and reset pulses to an image sensor array 230 on a plurality of read and reset lines 225-1, 225-2, . . . , 225-N.

The image sensor array (or image array) 230 may include a plurality of image sensors 232 arranged in a matrix. Each of the plurality of image sensors 232 may convert an optical image into an electric signal. According to example embodiments, each image sensor 232 may be a CMOS image sensor, such as, an active-pixel sensor (APS) or the like. Accordingly, in one example, the image sensor array 230 may be an APS array. Each of the plurality of read and reset lines 225-1, 225-2, . . . , 225-N may correspond to a row or groups of adjacent rows among the plurality of rows ROW-1 through ROW-N in the image sensor array 230. Each of the plurality of rows ROW-1 through ROW-N may include a plurality of image sensors 232. Because image sensor arrays such as the image sensor array 230 are well-known, a detailed description will be omitted.

Still referring to FIG. 1, according to at least this example embodiment, from the x-decoder 220 to the image sensor array 230, read and reset pulses for a first row (“line”) ROW-1 may be output via a first output line 225-1, read and reset pulses for a second row ROW-2 may be output via a second output line 225-2, etc.

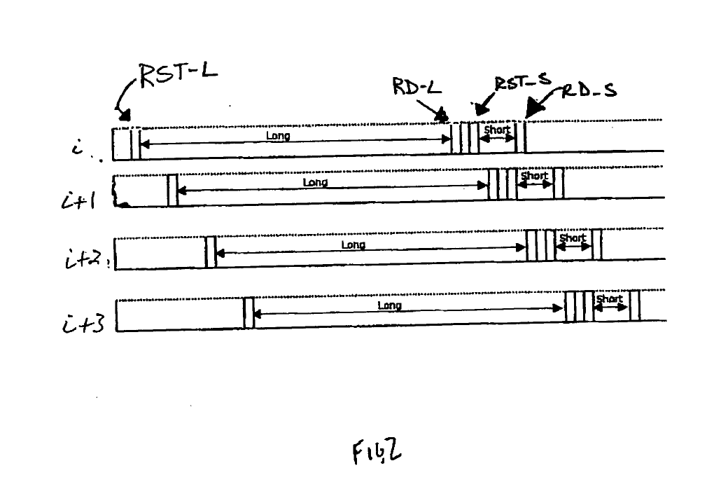

FIG. 2 is a timing diagram showing example timing of reset and read pulses output by the x-decoder 220 for four consecutive rows i, i+1, i+2, and i+3, where i represents one of rows ROW-1 through ROW-(N−3). As shown, for row i for example, the x-decoder 220 may output a first reset pulse RST-L, a first read pulse RD-L, a second reset pulse RST-S and a second read pulse RD-S, sequentially. Although only a single iteration of this output is shown in FIG. 2, it is understood that these outputs may be repeated iteratively.

Example operation of the image sensing apparatus shown in FIG. 1 will now be described with regard to the timing diagram shown in FIG. 2. In some instances, example embodiments will be described with regard to a single row i from among the plurality of rows ROW-1 through ROW-N. However, it will be understood that the same processes/operations may be performed with regard to each of the plurality of rows ROW-1 through ROW-N.

Referring to FIGS. 1 and 2, in response to a first reset pulse RST-L received via read/reset line 225-1, image sensors in row i may be exposed to light. The image sensors in row i may be exposed until a subsequent first read signal RD-L for row i is received by the image sensor array 230 via read/reset line 225-1. The time period between the first reset pulse RST-L and the first read pulse RD-L is referred to herein as the long exposure or long integration period. When the first read signal RD-L for row i is received, the exposure values of row i may be read and output as first output signals (or first exposure data signals) S-1-1, S-1-2, . . . , S-1-M (e.g., analog signals) via output lines 235-1, . . . , 235-M, respectively. Each of output signals S-1-1, S-1-2, . . . , S-1-M corresponds to a signal read from one of M image sensors in row i of the image sensor array 230.

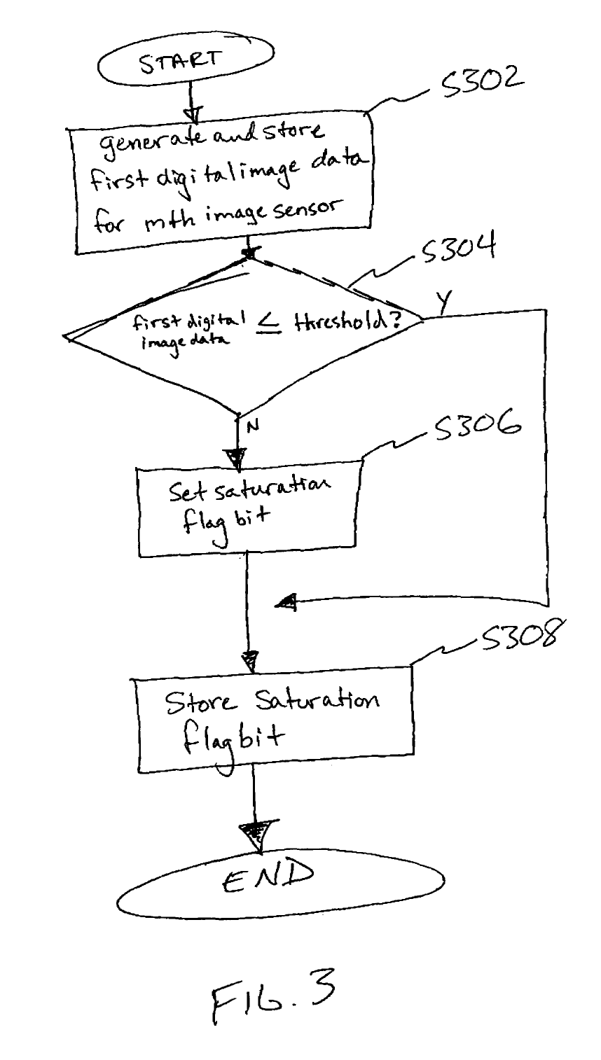

Still referring to FIG. 1, the first output signals S-1-1, S-1-2, . . . , S-1-M for row i may be output to sample and hold (S&H)/analog to digital converter (ADC) circuit 240. The S&H/ADC circuit 240 may process the received first output signals S-1-1, S-1-2, . . . , S-1-M to generate first digital image data, and store the digital image data in a register array 250. FIG. 3 is a flow chart illustrating a method of processing the first output signals S-1-1, S-1-2, . . . , S-1-M according to an example embodiment, which may be performed at the S&H/ADC circuit 240. The method shown in FIG. 3 will be described with regard to an m-th image sensor from among the M image sensors in row i (where m is between 1 and M, inclusive). However, it will be understood that the same process/operation may be performed with regard to each of the M image sensors in row i.

Referring to FIGS. 1 and 3, at S302 the S&H/ADC circuit 240 may generate first digital image data based on the first output signal S-1-m for the m-th image sensor and the generated first digital image data may be stored in a register at register 250. According to at least one example embodiment, the S&H/ADC circuit 240 may generate the first digital image data by digitizing the first output signal S-1-m.

For example, the S&H/ADC circuit 240 may sample the first output signal S-1-m (e.g., using correlated double sampling) by sample and hold (S&H) units. The S&H units register pixel voltage levels on a capacitor. S&H units allow stable pixel voltage levels for the duration of ADC circuit activity in case of relatively short access to pixel data. The S&H/ADC circuit 240 may then compare the values registered by the S&H units for the m-th image sensor with a ramp voltage Vramp. In this example embodiment, a counter (not shown) may begin counting when the ramp voltage Vramp begins, and at the time of the compare-match signal. The digital value of the counter may be latched in a register at register circuit 250. The compare-match signal is a signal generated by the S&H/ADC circuit 240 when detecting a match between the pixel voltage level on one or more S&H units and the Vramp voltage level.

The digital value of the counter latched in the register may be proportional to (or indicative of) the amount of light accumulated on m-th image sensor during the long exposure period. The digital value of the counter is referred to herein as first digital image data.

Still referring to FIGS. 1 and 3, at S304 the S&H/ADC circuit 240 may determine whether to set a saturation flag bit based on the value of the first digital image data. The saturation flag bit may be used to indicate whether the m-th image sensor reached or was relatively close to reaching saturation during the long exposure period. In one example, image sensors relatively close to saturation may have digital values between about 1900 and 2047, inclusive.

For example, at S304, the S&H/ADC circuit 240 may compare the first digital image data with a saturation threshold value. The saturation threshold value may be a digital value relatively close to a saturation value for the image sensor. For example, the saturation threshold value may be between about 1600 and 2047, inclusive.

If the value of the first digital image data is greater than the saturation threshold value, the S&H/ADC circuit 240 may set the saturation flag bit (e.g., to a first value, such as ‘1’ or logic ‘H”) at S306. The set saturation flag bit may be stored in association with the first digital image data for the m-th image sensor at S308.

Returning to S304, if the first digital image data is less than or equal to the saturation threshold value, the S&H/ADC circuit 240 may not set the saturation flag bit (e.g., the saturation flag bit may have a second value, such as ‘0’ or logic ‘L’). The unset saturation flag bit may be stored in association with the first digital image data for the m-th image sensor at S308.

Returning to FIG. 1, concurrently while the S&H/ADC circuit 240 processes the output signals S-1-1, S-1-2, . . . , S-1-M (e.g., as discussed above with regard to FIG. 3), the image array 230 may receive the second reset pulse RST-S. In response to the second reset pulse RST-S, image sensors 232 in row i may again be exposed (e.g., re-exposed) to light. The image sensors 232 in row i may be exposed until the subsequent second read signal RD-S for row i is received at the image sensor array 230. The time period between the second reset pulse RST-S and the second read pulse RD-S is referred to herein as the short exposure or short integration period.

When the second read signal RD-S for row i is received at the image sensor array 230, the exposure values of row i are again read and output via output lines 235-1, . . . , 235-M. Each of second output signals (or second exposure data signals) S-2-1, S-2-2, . . . , S-2-M from image sensor array 230 corresponds to a signal read from a specific one of the M image sensors in row i. The short exposure period may be shorter than the long exposure period. The length of the short exposure may be controllable and the ratio of the long to short exposure g may vary depending on the target dynamic range needed for a particular application. In one example, the ratio of the long to short exposure may be in a range of about 1 to about 128, inclusive.

The following discussion regarding the processing of the second output signals S-2-1, S-2-2, . . . , S-2-M will also be described with regard to the m-th image sensor from among the M image sensors in row i. However, it will be understood that the same process/operation may be performed with regard to each of the M image sensors in row i.

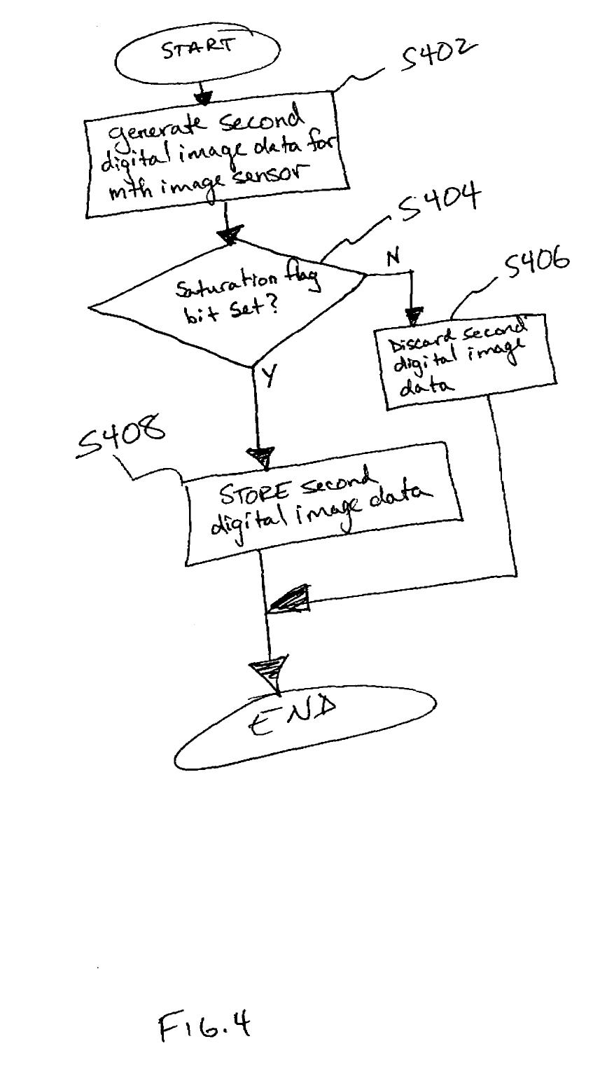

Still referring to FIG. 1, the second output signal S-2-m for the m-th image sensor may be processed by the S&H/ADC circuit 240 in the same or substantially the same manner as the first output signal S-1-m discussed above. However, the digital values generated by the S&H/ADC circuit 240 based on the second output signal S-2-m may be selectively stored in the register 240 based on the value of the first digital image data for the m-th image sensor. An example method for processing the second output signal S-2-m for the m-th image sensor will be described with regard to FIG. 4.

FIG. 4 is a flow chart illustrating a method for processing the second output signal S-2-m for the m-th image sensor according to an example embodiment.

Referring to FIG. 4, at S402 the S&H/ADC circuit 240 may generate second digital image data in the same or substantially the same manner as discussed above with regard to S302 in FIG. 3.

At S404, the S&H/ADC circuit 240 may check whether the saturation flag bit stored in association with the first digital image data for the m-th image sensor is set (e.g., to a first value, such as ‘1’ or logic ‘H’). If the saturation bit is set, the S&H/ADC circuit 240 determines that the m-th image sensor was at (or near) saturation during the previous long exposure period. If the S&H/ADC circuit 240 determines that the m-th image sensor was at (or near) saturation during the long exposure period, the second digital image data for the m-th image sensor may also be stored in the register circuit 250 at S408.

Returning to S404 in FIG. 4, if the saturation bit is not set (e.g., has a value of ‘0’ or logic ‘L’), the S&H/ADC circuit 240 determines that the m-th image sensor was not at (or near) saturation during the previous long exposure period. If the S&H/ADC circuit 240 determines that the image sensor was not at or near saturation, the digital value for the short exposure period may be discarded at S406.

Returning to FIG. 1, after processing the second digital image data for the m-th image sensor, the register 250 may output image data for the m-th image sensor to the merge circuit 260. If the second digital image data for the m-th image sensor has been discarded, then the image data 255 includes only the first digital image data. But, if the second digital image data for the m-th image sensor is stored in the register 250, then the image data 255 includes both first digital image data and the second digital image data. The saturation flag bit may also be output to the merge circuit 260, whether set or not set. The saturation flag bit indicates whether the merge circuit 260 should combine multiple digital image data for the m-th image sensor.

Upon receipt of the image data and saturation flag bit for the m-th image sensor, if the saturation flag bit is set (e.g., to ‘1’ or logic ‘H’), the merge circuit 260 may combine the first digital image data and the second digital image data using weight and estimation functions, parameters and an auto-calibrated offset.

In one example, a first digital image DI1 may be multiplied by ratio g to obtain the same or substantially the same digital scale as a second digital image DI2. The first and second digital images DI1 and DI2 may be combined using a weight function ƒ1 and an estimation function ƒ2.

The weight function ƒ1 may be a smoothing function or simple weight function to smooth the combination of different images. For example, if min_d2<ƒ2(DI2)<max_d2, then:

$$f 1 ( DI 1 , DI 2 ) = g * DI 1 * w + DI 2 * ( 1 - w ) , where$$

$$w = ( \frac{f 2 ( DI 2 ) - min\_d 2}{max\_d 2 - min\_d 2} )$$

The value max_d2 is maximum threshold parameter and the value min_d2 is a minimum threshold parameter The weight function ƒ1 may be a continuous, linear function.

The estimation function ƒ2 may provide a local estimate of a pixel in the second digital image DI2. The estimation function ƒ2 may be used to choose pixels for the resultant output image. An example of an estimate obtained using the estimation function ƒ2 is a function suitable for determining the maximal color or average luminance in the neighborhood of a pixel of the second digital image DI2. For example, in a 2×2 pixel neighborhood,

$$f 2 ( x ) = max ( x , x 1 , x 2 , x 3 , x 4 ) or f 2 ( x ) = ( \frac{( x + x 1 + x 2 + x 3}{4} ) ,$$

where x1, x2, x3 are pixels in the 2×2 neighborhood of the pixel x.

If the estimation function for the second digital image ƒ2(DI2) is larger then the maximum threshold parameter max_d2, then g*DI1 has a weight of 1 and the second digital image DI2 has a weight of 0. If the estimation function for the second digital image ƒ2(DI2) is smaller than the minimum saturation threshold parameter min_d2, then the second digital image DI2 has weight of 1 and g*DI1 has weight of 0.

As noted above, the merge circuit 260 may also combine the first digital image data and the second digital image data using an auto-calibrated offset. The auto-calibrated offset between the first and second digital image data is calculated as an average of (g*DI1−DI2) for image pixels in which:

min_{—}d2<ƒ2(DI2)<max_{—}d2; and

min_{—}d1<ƒ3(DI1)<max_{—}d1;

where ƒ3 is an estimation function, for example, one in which ƒ3(DI1)=DI1, max_d1 is another maximum threshold parameter, and min_d1 is another minimum threshold parameter. The auto-calibrated offset may be applied (e.g., subtract from) the scaled first digital image data g*DI1.

The merger output may be described by the following pseudo-code, in which DIcombined represents the combined image:
if ƒ2(DI2) < min_d2
   DIcombined = DI2;
else if ƒ2(DI2) > max_d2
   DIcombined = g*DI1 − offset;
else
   DIcombined = ƒ1(g*DI1 − offset, DI2);

Referring still to FIG. 1, if the saturation flag bit is not set (e.g., has a value ‘0’ or logic ‘L’), the merge circuit 260 recognizes that combining first and second digital image data is not necessary, and no combination is performed.

The merge circuit 260 may output resultant image data for the m-th image sensor to a display or other device such as a memory at which the image data may be stored. The image data for the m-th image sensor is either image data resulting from a single (e.g., long) exposure or a combination of multiple (e.g., long and short) exposures. The resultant image data may be used to generate an image using any well-known technique or method.

As noted above, although example processes/operations have been discussed with regard to a single row i and an m-th image sensor, it will be understood that the same or substantially the same process may be performed with regard to each of rows ROW-1 through ROW-N and each of the plurality of image sensors 232 of the image sensor array 230 to generate a resultant image.

As shown in FIG. 2, the x-decoder 220 may output similar reset and read pulses that are time shifted relative to one another. For each of rows ROW-1 through ROW-N of the image sensor array 230, the above described methods and/or processes may be repeated with regard to each row or groups of rows in the image sensor array 230.

Although example embodiments have been described with regard to an example in which a long exposure period is followed by a shorter exposure period, example embodiments may also be utilized in connection with a situation in which a long exposure period follows a short exposure period.

Moreover, example embodiments may also be utilized to generate image data based on more than two exposures. For example, resultant image data may be generated based on three or more exposures, at least two of which (or all three or more) may be different (e.g., a short-long-short, long-medium-long, etc.).

Although example embodiments have been described with regard to combining short and long exposures as necessary, alternatively, the image data associated with the short exposure may replace the long exposure data stored at the register 250. In this example embodiment, the merge circuit 260 need not combine image data from multiple exposures at an image sensor. This alternative process may be used, for example, in the case of relatively high illumination scenes.

Example embodiments being thus described, it will be obvious that the same may be varied in many ways. Such variations are not to be regarded as a departure from the present invention, and all such modifications are intended to be included within the scope of the present invention.

We claim:

1. A method of operating an image sensor apparatus, the method comprising:
generating first digital image data based on a first exposure data signal, the first exposure data signal being indicative of an exposure level of an image sensor during a first exposure period;
storing the first digital image data;
generating second digital image data based on a second exposure data signal, the second exposure data signal being indicative of an exposure level of the image sensor during a second exposure period, the second exposure period being shorter than the first exposure period, and the second exposure period following the first exposure period;
selectively storing the second digital image data associated with the image sensor based on a value of the first digital image data associated with the image sensor.

2. The method of claim 1, further comprising:
first exposing the image sensor to light for the first exposure period, and wherein
the generating of the first digital image data includes,
receiving the first exposure data signal from the image sensor, and
digitizing the first exposure data signal to generate the first digital image data.

3. The method of claim 2, further comprising:
second exposing the image sensor to light for the second exposure period, and wherein
the generating of the second digital image data signal includes,
receiving the second exposure data signal from the image sensor, and
digitizing the second exposure data signal to generate the second digital image data.

4. The method of claim 3, wherein the second exposing of the image sensor occurs concurrently with the digitizing of the first exposure data signal or storing of the first digital image data.

5. The method of claim 3, wherein the second exposing further includes,
applying a reset signal to a row of an image sensor array including the image sensor to begin the second exposure period; and
applying a read signal to the row of the image sensor array to end the second exposure period.

6. The method of claim 5, wherein the applying of the read signal initiates reading out of the second exposure data signal from the image sensor.

7. The method of claim 2, wherein the first exposing further includes,
applying a reset signal to a row of an image sensor array including the image sensor to begin the first exposure period; and
applying a read signal to the row of the image sensor to end the first exposure period.

8. The method of claim 7, wherein the applying of the read signal initiates reading out of the first exposure data signal from the image sensor.

9. The method of claim 1, further including,
exposing the image sensor to light for the second exposure period, and wherein
the generating of the second digital image data signal includes,
receiving the second exposure data signal from the image sensor, and
digitizing the second exposure data signal to generate the second digital image data.

10. The method of claim 9, wherein the exposing further includes,
applying a reset signal to a row of an image sensor array including the image sensor to begin the second exposure period; and
applying a read signal to the row of the image sensor array to end the second exposure period.

11. The method of claim 10, wherein the applying of the read signal initiates reading out of the second exposure data signal from the image sensor.

12. The method of claim 1, wherein the selectively storing includes,
analyzing a saturation flag bit associated with the stored first digital image data, the saturation bit being indicative of whether a value of the first digital image data is greater than a threshold value, and
selectively storing the second digital image data based on the value of the saturation flag bit.

13. The method of claim 1, further comprising:
comparing the value of the first digital image data with a threshold value,
setting a saturation flag bit to a first value if the value of the first digital image data is greater than the threshold value, and
storing the saturation flag bit in association with the first digital image data.

14. The method of claim 13, wherein the selectively storing stores the second digital image data if the saturation bit is set to a first value.

15. The method of claim 13, wherein the second digital image data is not stored if the saturation bit is not set to a first value.

16. The method of claim 13, further comprising:
combining the first digital image data and the second digital image data to generate resultant digital image data if the saturation bit is set to a first value.

17. The method of claim 16, wherein the combining further includes,
scaling the first digital image data according to a ratio between the first exposure period and the second exposure period such that the first and second digital image data have the same digital scale,
generating an estimation result by evaluating an estimation function based on the second digital image data,
comparing the estimation result with a first and a second threshold value, the first threshold value being greater than the second threshold, and
weighting the first and second digital image data based on a result of the comparing step, and
combining the weighted first and second digital image data to generate the resultant digital image data.

18. The method of claim 17, wherein the combining further includes,
calculating an auto-calibrated offset based on the first and second digital image data, and
applying the auto-calibrated offset to the scaled first digital image data when combining.

19. The method of claim 18, wherein the calculating of the auto-calibrated offset further includes,
subtracting a value of each of a portion of the pixels of the second digital image data from a corresponding pixel value of the scaled first digital image data to generate a plurality of difference results; and
calculating an average of the generated difference results.

20. The method of claim 1, further comprising:
generating third digital image data based on a third exposure data signal, the third exposure data signal being indicative of an exposure level of the image sensor during a third exposure period, the third exposure period being different from at least one of the first and second exposure periods, and the third exposure period following the second exposure period;
selectively storing the third digital image data associated with the image sensor based on a value of at least one of the first and second digital image data associated with the image sensor.

21. A method of operating an image sensor apparatus, the method comprising:
generating first digital image data based on a first exposure data signal, the first exposure data signal being indicative of an exposure level of an image sensor during a first exposure period;
storing the first digital image data;
generating second digital image data based on a second exposure data signal, the second exposure data signal being indicative of an exposure level of the image sensor during a second exposure period, the second exposure period being different from the first exposure period, and the second exposure period following the first exposure period;
selectively storing the second digital image data associated with the image sensor based on a value of the first digital image data associated with the image sensor.

22. The method of claim 21, further comprising
generating third digital image data based on a third exposure data signal, the third exposure data signal being indicative of an exposure level of the image sensor during a third exposure period, the third exposure period being different from at least one of the first and second exposure periods, and the third exposure period following the second exposure period;
selectively storing the third digital image data associated with the image sensor based on a value of at least one of the first and second digital image data associated with the image sensor.

23. An image sensor apparatus comprising:
an image sensor array including a plurality of image sensors arranged in a plurality of rows and columns, each image sensor being configured to output a first and a second exposure data signal, the first exposure data signal being indicative of an exposure of the image sensor to light during a first exposure period, and the second exposure data signal being indicative of an exposure of the image sensor to light during a second exposure period, the first exposure period being longer than the second exposure period, and the second exposure period being subsequent to the first exposure period;
a sample and hold unit configured to, for each image sensor, digitize the first exposure data signal to generate first digital image data, and digitize the second exposure data signal to generate second digital image data; and
a storage circuit configured to, for each image sensor, store the first digital image data, and selectively store the second digital image data based on a value of the stored first digital image data.

24. The apparatus of claim 23, wherein the second digital image data is stored in the storage circuit if the value of the first digital image data is greater than a saturation threshold value.

25. The apparatus of claim 23, wherein the storage circuit selectively stores, for each image sensor, the second digital image data based on a value of a saturation flag bit, the saturation flag bit being indicative of whether the value of the first stored digital image data is above a saturation threshold value.

26. The apparatus of claim 25, wherein the storage circuit stores, for each image sensor, the second digital image data if the value of a saturation flag bit indicates that the value of the first stored digital image data is greater than a saturation threshold value.

27. The apparatus of claim 23, wherein the sample and hold unit is further configured to,
compare the value of the first digital image data with a saturation threshold value,
set a saturation flag bit to a first value if the value of the first digital image data is greater than the saturation threshold value,
store the saturation flag bit in association with the first digital image data, wherein
the storage circuit stores the second digital image data if the saturation flag bit is set to the first value.

28. The apparatus of claim 27, wherein the sample and hold unit is further configured to discard the second digital image data if the saturation flag bit is not set to the first value.
